(19) United States
(12) Patent Application Publication
(10) Pub. No.: US 2014/0032978 A1
(43) Pub. Date: Jan. 30, 2014

(54) SERVER AND METHOD OF MONITORING BASEBOARD MANAGEMENT CONTROLLER

(71) Applicant: Hon Hai Precision Industry Co., Ltd., New Taipei (TW)

(72) Inventor: YU-CHEN HUANG, New Taipei (TW)

(21) Appl. No.: 13/941,570

(22) Filed: Jul. 15, 2013

(30) Foreign Application Priority Data
Jul. 30, 2012 (TW) 101127528

(51) Int. Cl. G06F 11/34

(52) U.S. Cl. CPC G06F 11/3409
USPC 714/47.2

(57) ABSTRACT

A server includes a baseboard management controller. The server controls a real time clock to send a clock signal to a platform controller hub (PCH) in a predefined interval. When a system management interrupt has been activated, the server executes a monitoring instruction to obtain a state value of the BMC. When the state value of the BMC is not the same as a normal state value, the server is restarted. An event log of the BMC is written to the BMC and an alarm is raised.

### BACKGROUND

1. Technical Field

Embodiments of the present disclosure relate to baseboard management controller (BMC) management technology, and more particularly to a server and a method of monitoring a baseboard management controller.

2. Description of related art

A baseboard management controller (BMC) of a server can keep an operating system of the server stably. However many systems do not monitor the BMC. When or if the BMC is malfunctioning, the operating system of the server is not being monitored, and an administrator of the server may not receive malfunctioning alerts of the server. In addition, hardware of the server may be damaged or destroyed.

### BRIEF DESCRIPTION OF THE DRAWINGS

FIG. 1 is a block diagram of one embodiment of an electronic device including a monitoring system.

FIG. 2 is a block diagram of one embodiment of function modules of the monitoring system in FIG. 1.

FIG. 3 is a flowchart of one embodiment of a method of monitoring a baseboard management controller.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language. One or more software instructions in the modules may be embedded in firmware, such as in an erasable programmable read only memory (EPROM). The modules described herein may be implemented as either software and/or hardware modules and may be stored in any type of non-transitory computer-readable medium or other storage system. Some non-limiting examples of non-transitory computer-readable media include CDs, DVDs, BLU-RAY, flash memory, and hard disk drives.

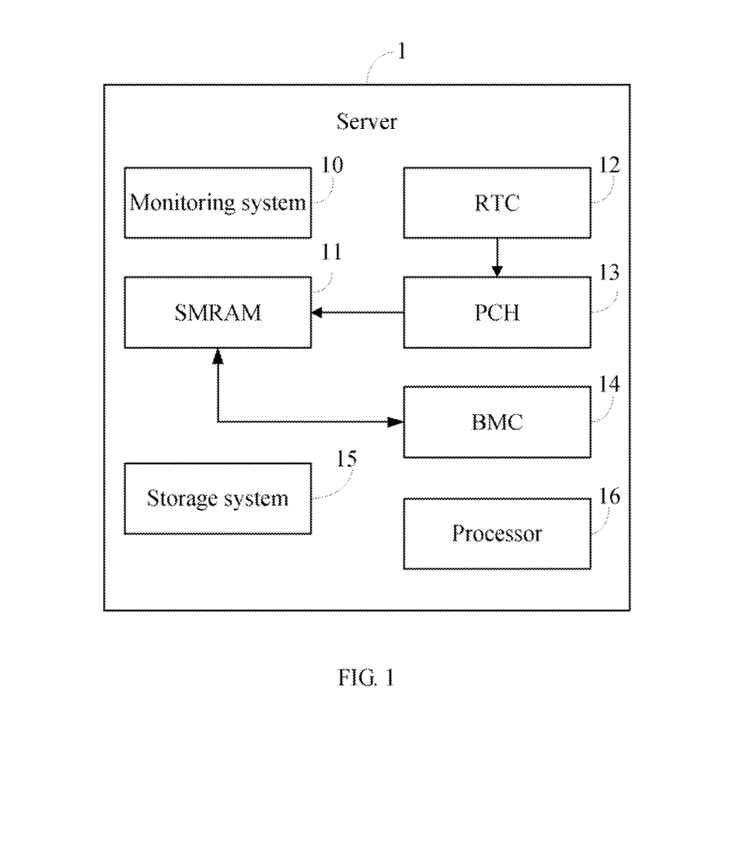

FIG. 1 is a block diagram of one embodiment of a server 1 including a monitoring system 10. The server 1 includes a system management random access memory (SMRAM) 11, a real time clock (RTC) 12, a platform controller hub (PCH) 13, a baseboard management controller (BMC) 14, a storage system 15 and a processor 16. The SMRAM 11 stores a monitoring instruction. The monitoring instruction obtains a status value of the BMC 14 in an interval according to a clock signal of the RTC 12. The monitoring system 10 determines whether an operating system of the server 1 and the BMC 14 are in a normal state.

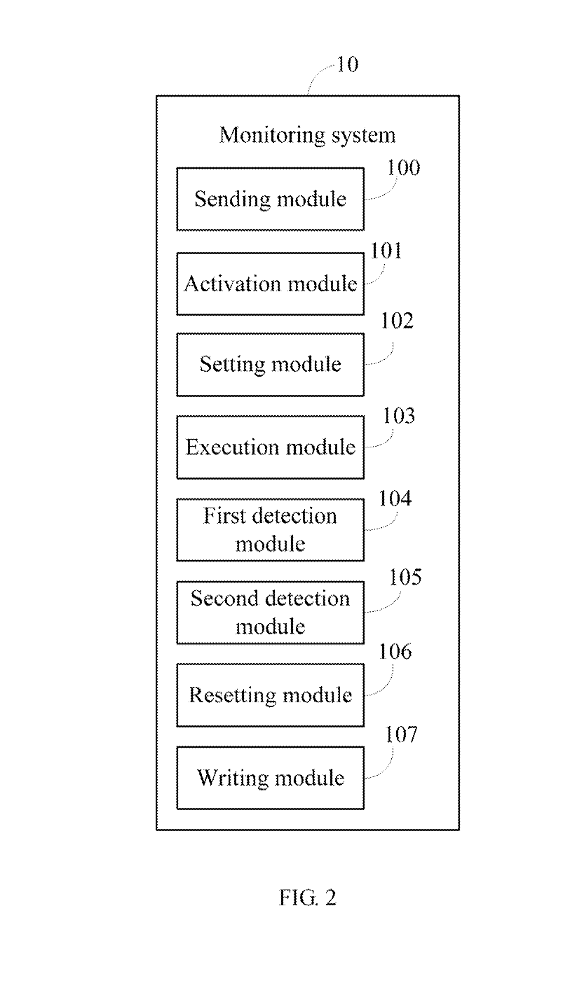

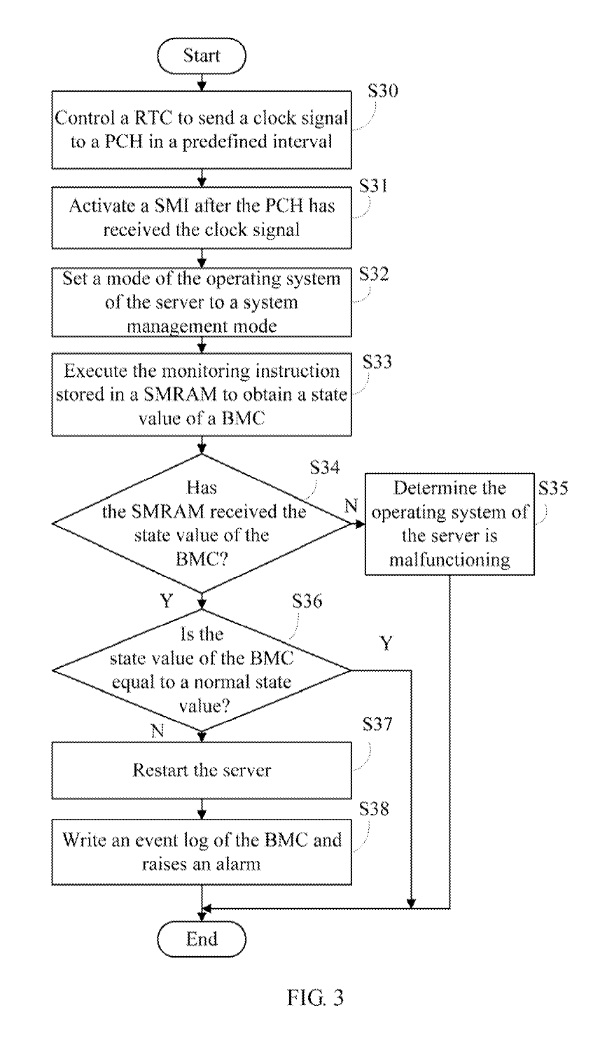

As shown in FIG. 2, the monitoring system 10 includes a plurality of function modules, such as a sending module 100, an activation module 101, a setting module 102, an execution module 103, a first detection module 104, a second detection module 105, a resetting module 106 and a writing module 107. The modules 100-107 include computerized code in the form of one or more programs that are stored in the storage system 15. The computerized code includes instructions that are executed by the processor 16, to provide aforementioned functions of the monitoring system 10. Detailed functions of the modules 100-107 are given in reference to FIG. 3.

FIG. 3 is a flowchart of one embodiment of method of monitoring baseboard management controller. Depending on the embodiment, additional steps may be added, others removed, and the ordering of the steps may be changed.

In step S30, when the server 1 is powered on, the sending module 100 controls the RTC 12 to periodically send a clock signal to the PCH 13. For example, the RTC 12 may send a clock signal to the PCH 13 every second.

In step S31, the activation module 101 activates a system management interrupt (SMI) after the PCH 13 has received the clock signal. In one embodiment, the activation module 101 changes a state of a SMI trigger pin of the PCH 13 to activate the SMI.

In step S32, the setting module 102 sets a mode of the operating system of the server 1 to a system management mode (SMM).

In step S33, the execution module 103 executes the monitoring instruction stored in the SMRAM 11 to obtain a state value of the BMC 14. In one embodiment, when the monitoring instruction is executed, the execution module 103 sends an obtaining instruction to the BMC 14. The BMC 14 feeds the state value of the BMC 14 back to the SMRAM 11 in response to receiving the obtaining instruction.

In step S34, the first detection module 104 detects whether the SMRAM 11 has received the state value of the BMC 14. If the SMRAM 11 has not received the state value of the BMC 14, step S35 is implemented, the first detection module 104 determines the operating system of the server 1 is malfunctioning, and the procedure ends. If the SMRAM 11 has received the state value of the BMC 14, step S36 is implemented.

In step S36, the second detection module 105 detects whether the state value of the BMC 14 is equal to a normal state value. If the state value of the BMC 14 is equal to the normal state value, the procedure ends. If the state value of the BMC 14 is not equal to the normal state value, step S37 is implemented.

In step S37, the resetting module 106 restarts the server 1 and recovers the last state value of the BMC 14.

In step S38, the writing module 107 writes an event log of the BMC 14 to the BMC 14, and raises an alarm. The event log of the BMC 14 includes the state value of the BMC 14, the time of the server 1 when the BMC 14 feedbacks the state value, for example.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A server comprising:
a processor; and
a non-transitory computer-readable medium that stores one or more programs, which comprise instructions which when executed by the processor of the electronic device, performs operations of:
(a) controlling a real time clock (RTC) of the server to periodically send a clock signal to a platform controller hub (PCH) of the server;
(b) activating a system management interrupt after the PCH has received the clock signal;
(c) executing a monitoring instruction to obtain a state value of a baseboard management controller (BMC); and
(d) restarting the server, writing an event log of the BMC and raising an alarm when the last state value of the BMC is not equal to a normal state value.

2. The server as claimed in claim 1, after operation (b) and before operation (c) the method further comprising:
setting a mode of an operating system of the server to a system management mode.

3. The server as claimed in claim 2, wherein the operations further comprise:
determining the operating system of the server is malfunctioning when the state value of the BMC is not received by the server.

4. The server as claimed in claim 1, wherein the monitoring instruction is stored in the system management random access memory (SMRAM) of the server.

5. A method being executed by a processor of a server, comprising steps:
(a) controlling a real time clock (RTC) of the server to periodically send a clock signal to a platform controller hub (PCH) of the server;
(b) activating a system management interrupt after the PCH has received the clock signal;
(c) executing a monitoring instruction to obtain a state value of a baseboard management controller (BMC); and
(d) restarting the server, writing an event log of the BMC and raising an alarm when the last state value of the BMC is not equal to a normal state value.

6. The method as claimed in claim 5, after step (b) and before step (c) the method further comprising:
setting a mode of an operating system of the server to a system management mode.

7. The method as claimed in claim 6, wherein the method further comprises:
determining the operating system of the server is malfunctioning when the state value of the BMC is not received by the server.

8. The method as claimed in claim 5, wherein the monitoring instruction is stored in the system management random access memory (SMRAM) of the server.

9. A non-transitory computer-readable medium having stored thereon instructions that, when executed by a processor of a server, cause the processor to perform operations of:
(a) controlling a real time clock (RTC) of the server to periodically send a clock signal to a platform controller hub (PCH) of the server;
(b) activating a system management interrupt after the PCH has received the clock signal;
(c) executing a monitoring instruction to obtain a state value of a baseboard management controller (BMC); and
(d) restarting the server, writing an event log of the BMC and raising an alarm when the last state value of the BMC is not equal to a normal state value.

10. The non-transitory computer-readable medium as claimed in claim 9, after step (b) and before step (c) the method further comprising:
setting a mode of an operating system of the server to a system management mode.

11. The non-transitory computer-readable medium as claimed in claim 10, wherein the method further comprises:
determining the operating system of the server is malfunctioning when the state value of the BMC is not received by the server.

12. The non-transitory computer-readable medium as claimed in claim 9, wherein the monitoring instruction is stored in the system management random access memory (SMRAM) of the server.
